(19) United States
(12) Patent Application Publication
(10) Pub. No.: US 2016/0312152 A1
(43) Pub. Date: Oct. 27, 2016

(54) FREE FLOWING AQUEOUS LAMELLAR GEL LAUNDRY DETERGENT LIQUID COMPRISING EPEI

(71) Applicant: CONOPCO, INC., D/B/A UNIVEVER, New Jersey, NJ (US)

(72) Inventors: Johanna Margareta BORNÉ, Lund (SE); Dragomir Nikolov GANCHEV, Bromborough, Wirral, Merseydide (GB)

(73) Assignee: CONOPCO, INC. D/B/A UNILEVER, Englewddd Cliffs (US)

(21) Appl. No.: 15/103,319

(22) PCT Filed: Dec. 4, 2014
(86) PCT No.: PCT/EP2014/076629

§ 371 Date: Jun. 10, 2016

(30) Foreign Application Priority Data
Dec. 16, 2013 (EP) EP13197350.5

(51) Int. Cl. C11D 3/00; C11D 3/36; C11D 11/00; C11D 1/14; C11D 17/00; C11D 3/37; C11D 1/29

(52) U.S. Cl. CPC C11D 3/0036; C11D 3/3707; C11D 3/3715; C11D 3/361; C11D 1/29; C11D 1/143; C11D 17/003; C11D 11/0017; C11D 17/0026

(57) ABSTRACT

A free flowing aqueous lamellar gel laundry detergent liquid comprising, in addition to water: a) 20 to 35 wt % of a surfactant system in the form of vesicles comprising potassium neutralised linear alky benzene sulfonate anionic surfactant (LAS), alkyl ether sulphate anionic surfactant (AES) and nonionic surfactants, b) at least 3 wt % of a first nonionic polymeric material (EPEI) which is a water-soluble fabric cleaning polymer; c) from 0.1 to 1 wt % of a second nonionic polymeric material (Pluronic) which is a tri-block polymer with a hydrophobic midblock and two hydrophilic end-blocks with an HLB of at least 20 d) optionally, a polyester soil release polymer and e) optionally, at least 2 wt % 1-hydroxyethane 1,1-diphosphonic acid (HEDP).

### TECHNICAL FIELD

This invention relates to free flowing pourable physically stable aqueous lamellar gel laundry detergent liquids comprising ethoxylated polyethyleneimine (EPEI) and optionally also 1-hydroxyethane 1,1-diphosphonic acid (HEDP) to boost cleaning performance.

### BACKGROUND

To further improve the environmental profile of liquid laundry detergents it is proposed to reduce the volume of laundry detergent dosed per wash-load and to add various highly weight efficient ingredients to the composition to boost cleaning performance. Two such ingredients are: (i) ethoxylated polyethyleneimine (EPEI) which is known to improve the particulate soil removal when in wash surfactant levels are low, especially when used in combination with a polyester based soil release polymer; and (ii) 1-hydroxyethane 1,1-diphosphonic acid (HEDP) which is known in laundry formulations as a sequestrant/chelating agent to control Ca²⁺ and/or Mg²⁺ levels and to sequestrate metal ions to help to remove some types of “bleachable” stains (wine, tea, etc.). It is highly desirable to include HEDP into a concentrated liquid because inclusion of bleach is very difficult due to its low weight efficiency. Suitable levels of HEDP are difficult to add to isotropic liquids due to phase incompatibilities. Suitable levels of EPEI may also cause physical instability problems in isotropic liquids that require potentially inefficient formulation changes to solve. Addition of a structurant such as hydrogenated castor oil can help to reduce problems due to inclusion of low levels of EPEI but even it cannot be the full solution. HEDP can be made more stable by selection of more soluble salts as taught in EP 517 605 (NLN), especially the potassium salt.

The problems associated with making stable isotropic liquids, whether externally structured or not, comprising EPEI and HEDP has led to renewed interest in lamellar gel compositions that can be designed to have intrinsic compositional stability and can be formulated with sufficiently high pour viscosity that any sparingly soluble detergency boosting ingredients can be stably dispersed within the lamellar gel. Two problems were encountered when formulating these gel compositions. Firstly, the EPEI was found to have an adverse effect on the rheological stability of the lamellar gel, promoting osmotic compression and depletion flocculation and loss of structure. Secondly, the HEDP could form highly crystalline structures within the lamellar gel, especially at low temperatures. These two problems meant that to include these ingredients would require more than minor changes to the known lamellar gel compositions.

WO 2007/135645 (P&G) discloses, in Table I, hand dish-wash liquid formulations containing as a surfactant system: high levels of SLES, nonionic and amine oxide, together with up to 2 wt % EPEI and 1 wt % Pluronic. No reason is given for inclusion of the Pluronic. The Pluronics used are L81 and L43. L81 has a HLB of 2 and L43 has a HLB of 12. All the examples use EPEI with 10 or fewer moles of ethoxylation per nitrogen. No HEDP is included. No LAS is used. NaCl is added.

The reduction of the water content of a lamellar phase may be referred to as osmotic compression. WO 93/22417 (Unilever) discloses use of PEG (polyethylene glycol polymer) material to reduce the water content of the lamellar phase (p 29 lines 9-17). WO 90/15857 (Unilever) also discloses use of PEG to reduce the water content of the lamellar phase (p 29 last paragraph). No EPEI or HEDP is used and the preferred electrolytes used to form the gels are sodium salts.

WO 2011/143321 (P&G) discloses in Example 4C a possible gel composition with 1.5 wt % EPEI and LAS/LES/NI. This is insufficient EPEI to provide an effect in a concentrated liquid. No HEDP is present. The compositions are alkaline, no information is given about how they are neutralised. Example 4C requires an undisclosed neutralising material to be added as it contains linear alkylbenzene sulphonic acid. Sodium and Potassium hydroxides are apparently equally preferred.

WO 99/49009 (P&G) discloses some liquid detergent compositions; some of which may be gels. A combination of HEDP and EPEI is always present, soil release polymer is not used and all compositions are neutralised and/or have pH adjusted using sodium hydroxide. The NaOH used can give unstable compositions with poor rheology.

J C van der Pas et al (Colloid & Surfaces A: 1994, Vol 85 p 221-36) discuss the use of decoupling polymers and refer to osmotic attraction in high electrolyte conditions. Langmuir, 1993, Vol 9, p 956-61 discusses the packing of nonionic surfactants in lamellar liquids. Colloid & Surfaces 1992, Vol 68 p 127-39 discusses the effects of free polymers on osmotic compression.

Brooks and Cates (J Chem. Phys. 1993 Vol 99 p 5467-80) discuss the effect of added polymer in dilute lamellar surfactant phases.

J F Hessel et al. (ACS Symposium Series (1993), 532 (Colloid-Polymer Interactions), 241-52) discuss osmotic compression. The effect of water soluble polymers (PEG or Sodium Polyacrylate) on dilute lamellar surfactants is considered.

It remains a problem to provide concentrated stable pourable lamellar gel compositions comprising high levels of difficult to include cleaning compounds, such as EPEI, HEDP and polyester soil release polymer (SRP).

### SUMMARY OF THE INVENTION

According to the present invention there is provided a free flowing aqueous lamellar gel laundry detergent liquid comprising, in addition to water:
a) 20 to 35 wt % of a surfactant system in the form of vesicles comprising potassium neutralised linear alky benzene sulfonate anionic surfactant (LAS), alkyl ether sulphate anionic surfactant (AES) and nonionic surfactants,
b) at least 3 wt % of a first nonionic polymeric material which is a water-soluble fabric cleaning polymer,
c) from 0.1 to 1 wt % of a second nonionic polymeric material which is a tri-block polymer with a hydrophobic midblock and two hydrophilic end-blocks with an HLB of at least 20,
d) optionally, a polyester soil release polymer, and
e) optionally, at least 2 wt %-hydroxyethane 1,1-diphosphonic acid (HEDP).

### DETAILED DESCRIPTION OF THE INVENTION

The first nonionic polymeric material is preferably ethoxylated polyethyleneimine, (EPEI), most preferably it is PEI(600)20EO, a polymer with polyethyleneimine of average molecular weight 600 ethoxylated with ethylene oxide to give an average of 20 ethylene oxides per nitrogen. The first nonionic polymer is included into the composition to promote particulate, especially clay, soil removal from fabrics. This polymer also associates with the gel phase to cause unwanted osmotic compression of the vesicles. This compression makes the resulting liquid lose structure and it would therefore fail to hold in dispersion other desirable high performance ingredients that may be incorporated into a concentrated liquid based formulated to deliver effective cleaning from low in wash surfactant levels. Among such desirable ingredients may be mentioned relatively insoluble sequestrants, for example HEDP (1-hydroxyethane 1,1-diphosphonic acid), enzymes, and soil release polymer, especially soil release polymers with polyethylene terephthalate mid-blocks and polyethylene oxide (PEG) end block(s) that promote particulate soil removal from polyesters.

The second nonionic polymer sterically stabilizes the vesicles against osmotic compression/depletion flocculation, thus it opposes destabilizing effects of EPEI. Preferred as the second nonionic polymeric material (c) is a tri-block polymer for example those supplied under the name Pluronic. These are commonly described as nonionic surfactants and are PEO-PPO-PEO tri-block copolymers—with hydroxyl terminal groups. They have formula (I):

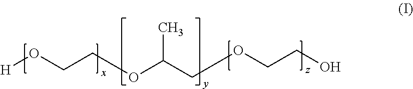

Wherein the HLB is at least 20 and preferably:

x and z (PEG end-block) is from 40 to 132, x is always is equal to z in commercially available Pluronics; and

y (hydrophobic PPO mid-block) is from 16 to 68.

A particularly preferred material is Pluronic F68 which has an HLB of 29.

These Pluronics associate with the surfactant lamellae in a lamellar gel: this association enables Pluronics with the required HLB to stabilize the lamellar gel. However, EPEI has been found to be disruptive for lamellar gel stability. By careful selection of Pluronic and its inclusion at the optimum level we have been able to stabilize EPEI containing lamellar gel compositions across a temperature range of 5 to 37° C. Surprisingly, a free flowing stable and high performance lamellar gel liquid comprising EPEI is thereby obtained.

Surfactant type and ratio, electrolyte level and EPEI level affect the stability of the lamellar gel. We have found that it is preferable that the following formulation rules are followed:
LAS:AES:NI: 1.5 to 2.5:0.7 to 1.5:1 to 2; preferably LAS:SLES:NI: 2:1:1.5;
Surfactant Level: 20 to 35 wt %, preferably 23 to 27 wt %
EPEI Level: 3 to 4 wt %
Pluronic: 0.5 to 0.6 wt %
Pluronic HLB: 20 to 30

This rules work especially well for Pluronic F68. The structural stability of these formulations can be seen using confocal laser microscopy and/or electron microscopy. Comparison of images from these analytical techniques demonstrates the extensive flocculation in systems with otherwise optimal surfactant ratios and desirable EPEI levels but without any Pluronic. Compositions comprising the inventive type and level of Pluronic are seen to have non-flocculated vesicle systems. Further confirmation of this structure has been made using diffusive wave spectroscopy, indicating optimal stability and flow properties of the compositions comprising both EPEI and the Pluronics.

Ratios of LAS:SLES:NI of from 2:1:1 to 1:1:2 are preferred. 1.5 wt % of a carbobetaine surfactant was also stably included in the liquid gel compositions. A 30 wt % to 35 wt % total surfactant level is preferred. However, compositions may be formulated at total surfactant levels of up to 50 wt %. Carbobetaine is stable in gels for composition space that would normally be unusable for a corresponding isotropic liquid. Stable liquids were made that also included 3.75 wt % TexCare™ SRN 170, 5.5 wt % EPEI, 1.6 to 2.6 wt % HEDP, and 3 to 8 wt % of the preferred lamellar gel generating salts.

1-hydroxyethane 1,1-diphosphonic acid (HEDP), trade name Dequest 2010 and available from Thermphos, is known in laundry formulations as a sequestrant/chelating agent to control Ca²⁺, Mg²⁺ levels and to sequestrate metal ions which helps to remove some types of stains (wine, tea, etc.). If it could be included at concentration of ca. 2.5 wt % in liquid lamellar gel compositions, a 25 ml dose of the liquid would deliver it at a level sufficient to give significant benefits on such stains. This level of HEDP inclusion is difficult to achieve in isotropic liquids, due to phase incompatibilities. Inclusion in a lamellar gel is also difficult due to the extensive crystallization of salts, which compromises the structure of the gel. This crystallisation is due to the low amount of free water in the compositions and low HEDP salt solubility; especially for its sodium salts.

Other ingredients commonly found in laundry liquids may also be included in the compositions in the amounts typically used. Other ingredients of the liquid may be as discussed in WO09153184.

We solved the problems discussed above for a 25 ml dose gel by using K⁺ salts for neutralisation of the LAS (KOH) and for the electrolyte gel former (Potassium acetate), this ensures that the relatively insoluble sodium salts of HEDP do not form and crystallise out on storage. Furthermore the combination of the use of potassium salts with the Pluronic enables stable inclusion of a polyester (polyethylene terephthalate mid-block) soil release polymer, TexCare™ SRN170 from Clariant, and HEDP in addition to the desired level of EPEI. We used Potassium Acetate as the lamellar generating salt instead of Sodium Chloride. Other suitable high solubility lamellar generating salts include Sodium Citrate, Potassium Citrate and Potassium Chloride. Mixtures of these electrolytes are also possible. The resulting gels are stable and exhibit low levels of crystallisation, as evidenced by microscopy.

Microscopic images of lamellar gels of different compositions show extensive crystallization in Sodium Chloride or Sodium HEDP containing gels and absence of any crystallisation in Potassium HEDP or Potassium Acetate containing gels.

The invention will now be further described with reference to the following non-limiting examples and to the drawings:

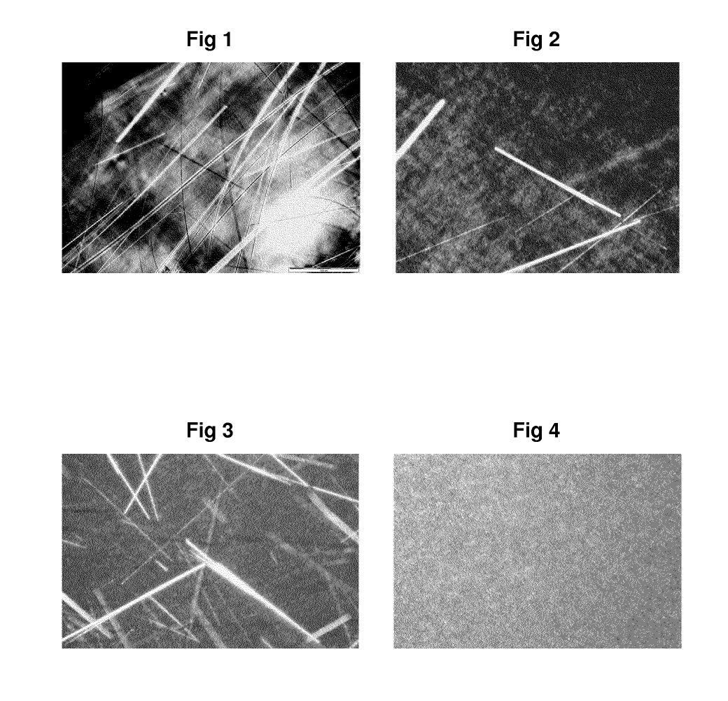

FIG. 1 is a microscopic view of Na-neutralized LAS, NaCl electrolyte, HEDP containing gel with no EPEI (comparative);

FIG. 2 is a microscopic view of K-neutralized LAS, NaCl electrolyte, HEDP gel with no EPEI (comparative);

FIG. 3 is a microscopic view of Na-Neutralized LAS, K-Acetate, HEDP gel with 5.5 wt % EPEI (comparative); and

FIG. 4 is a microscopic view of K-neutralized LAS, K-Acetate, and HEDP gel with 5.5 wt % EPEI according to the invention.

Liquids made for FIGS. 1 to 4 all used total Active Detergents levels of 35 wt %. The ratio of surfactants used was 1:1:2 LAS:SLES:NI. These formulations also included 1.5 wt % Carbobetaine. 3.75 wt % TexCare™ SRN 170 polyester soil release polymer, 5.5 wt % EPEI (except for FIGS. 1 and 2), 2 wt % HEDP (added as acid) and 3 wt % of the electrolyte (NaCl or K-acetate) which was used to induce lamellar formation (vesicles).

### EXAMPLES

### Example 1

This shows how the selection of the type of tri-block polymer affects composition stability. The base formulation used for these stability examples contained 24 wt % active detergent consisting of linear alkyl benzene sulfonate salt (LAS salt), sodium salt of lauryl ether sulphate (SLES) and nonionic 7EO in a ratio of 2:1:1.5. It also contained, 4 wt % EPEI, 3% TexCare™ SRN 170, Potassium Hydroxide to neutralise the LAS acid to make LAS salt, 3 to 4 wt % Potassium acetate for a stable lamellar gel, and water.

Table 1 shows the stability of this base lamellar gel laundry liquid composition containing EPEI to which 1 wt % of different types of Pluronic material were added. Formulation storage stability is assigned to a 3 point scale:

0=No stability advantage over base formulation

1=Improved stability over base formulation

2=Best stability achieved, passes all stability tests (except 45° C.)

Key properties of each Pluronic material are also given in Table 1. There is a clear relationship between increased composition stability and higher HLB of the Pluronic material added. No stable lamellar gel compositions were possible when the Pluronic HLB was below 20. There also seemed to be a correlation with higher EO:PO molecular ratios with materials having this ratio greater than 3 being preferred and greater than 5 most preferred. Most preferably the polymer materials also have a molecular weight of at least 5000. The skilled person will be able to find other suitable tri-block nonionic polymer materials satisfying these parameters.

TABLE 1
Tested polymers from the Pluronic family

| | Stability | | | | | |
|---|---|---|---|---|---|---|
| Material | Scale | Mw | EO | PO | EO/PO | HLB |
| L61 | 0 | 2000 | 4 | 31 | 0.13 | 2 |
| L31 | 0 | 1100 | 4 | 16 | 0.25 | 3.2 |
| L62 | 0 | 2500 | 11 | 34 | 0.32 | 7 |
| P103 | 0 | 4950 | 34 | 60 | 0.57 | 9 |
| P85 | 0 | 4600 | 52 | 40 | 1.30 | 16 |
| F127 | 1 | 12600 | 200 | 65 | 3.08 | 22 |
| F87 | 1 | 7700 | 122 | 40 | 3.05 | 24 |
| F38 | 1 | 4700 | 85 | 17 | 5.00 | 25 |
| F108 | 1 | 14600 | 265 | 50 | 5.30 | 27 |
| F68 | 2 | 8400 | 153 | 29 | 5.28 | 29 |

### Example 2

This shows the relative performance of different electrolytes. A lamellar gel detergent base liquid having from 24 to 27.5 wt % active detergent in the ratio, 2:1:1.5 LAS:SLES:NI, 4% EPEI, and 3% TexCare™ SRN 170 polyester soil release polymer was used for this example. The LAS was neutralised with Potassium Hydroxide and the amount of electrolyte used was 4 wt %.

Samples of each liquid were stored at room temperature for up to 1 month. If it occurred, crystallization usually appeared within a few days. Table 2 indicates the appearance after storage.

TABLE 2

| Electrolyte - gel former | Appearance after storage |
|---|---|
| NaCl | Crystallisation, proper lamellar (vesicular) |
| | structure |
| Na Citrate | Crystallisation, no proper lamellar |
| | structure induced |
| K Acetate | No crystals, proper lamellar (vesicular) |
| | structure |
| KNO₃ | No proper lamellar structure induced |
| K₂SO₄ | No proper lamellar structure induced |
| KCl | No crystals, proper lamellar (vesicular) |
| | structure |
| KSCN | No proper lamellar structure induced |
| KBr | No proper lamellar structure induced |
| K Benzoate | No proper lamellar structure induced |

### Example 3

From the initial electrolyte screening in Example 2 it can be seen that Potassium Acetate and Potassium Chloride both gave a good structure without crystallisation. Further work was done to optimise the level of inclusion and composition of suitable electrolyte systems to obtain a wide range of temperatures where stable gels could be formulated with the preferred Pluronic F68. The KCl and K Acetate were stored in a fully formulated lamellar liquid containing 24 wt % active detergent in a 2:1:1.5 LAS:SLES:NI ratio, 3 wt % TexCare™ SRN 170 soil release polymer, 4 wt % EPEI, and 0.5 wt % Pluronic F68. The results are given in Table 3.

TABLE 3

| Electrolyte system | Stability in presence of F68 |
|---|---|
| 4% K Acetate | Stable at all Temperatures (Freeze/ |
| | Thaw, 5° C., Room temp, 37° C. and 45° C.) |
| | (8-12 weeks stability at 45° C.) |
| 3% KCl | Some stability issues at 37° C. and 5° C. |
| 2% KCl | 2-4 weeks stability at 45° C. |
| 1% K Acetate | |

In this EPEI containing liquid the preferred acetate gives the best high temperature stability.

### Example 4

This example shows how the surfactant ratio chosen affects the formation of a physically stable lamellar phase. Visual observations recorded in Table 4 show that surfactant ratios other than those said to have “Optimal Stability” also produced a lamellar phase, but it was not stable and could phase separate rapidly. In all cases SLES was 3EO sodium salt. NI (nonionic) was a C12-14 alcohol ethoxylate with 7EO and the LAS was neutralised with potassium hydroxide.

TABLE 4

| LAS:SLES:NI ratio | Stability |
|---|---|
| 2:1:1.5 | Optimal stability |
| 2.5:1.5:1 | Optimal stability |
| 2:1:1 | Optimal stability |
| 2:1.6:0.6 | Unstable Lamellar phase formed |
| 1:1:2 | Unstable Lamellar phase formed |
| 1.6:1.4:1 | Unstable Lamellar phase formed |
| 1.8:1.2:1 | Unstable Lamellar phase formed |
| 2.25:1.75:1 | Unstable Lamellar phase formed |
| 2.5:1:1.5 | Unstable Lamellar phase formed |
| 2.5:0.5:1.5 | Unstable Lamellar phase formed |
| 3:1:1.5 | Unstable Lamellar phase formed |

### Example 5

### Effect of Pluronic and pSRP Concentration

In our formulation approach (2:1:1.5 LAS:SLES:NI, 2-4% KCl or K-Acetate) EPEI exerts osmotic compression and depletion flocculation, which we compensate with inclusion of Pluronic F68/F38. The inclusion of the selected Pluronic is able to give good control of pour viscosity, even in the presence of other polymers such as polyester soil release polymer (pSRP) which is often disastrous for maintenance of a high pour viscosity that may indicate a concentrated product. Surprisingly in these gels the soil release polymer cooperates with the Pluronic to increase the pour viscosity.

Table 5 shows the increased composition viscosity due to adding Pluronic F38 to a lamellar gel having a total surfactant active level of 27.5% and EPEI at 4%.

Table 6 shows the effect on viscosity of addition of Pluronic F68 to a lamellar gel having a total surfactant active level of 15 wt % and an EPEI level of 3%.

Table 7 shows the effect on viscosity of addition of Pluronic F68 to a different lamellar gel, having a total surfactant active level of 15 wt % 2:1:1.5 LAS:SLES:NI, and an EPEI level of 3 wt %. This composition further included a fixed amount of a polyester based soil release polymer.

Table 8 shows the effect on viscosity of addition of varying amounts of the polyester soil release polymer to a lamellar gel composition having a fixed amount of Pluronic F68 and having a total surfactant active level of 15 wt % and an EPEI level of 3 wt %.

TABLE 5

| Pluronic F38 concentration | Pouring Viscosity |
|---|---|
| (wt %) | (Pa · s) |
| 0 | 0.93 |
| 0.75 | 1.33 |
| 1.25 | 2.08 |
| 1.75 | 2.87 |

TABLE 6

| Pluronic F68 concentration | Pouring Viscosity |
|---|---|
| (wt %) | (Pa · s) |
| 1.25 | 0.97 |
| 1.5 | 1.06 |
| 1.75 | 1.6 |
| 2 | 1.9 |

TABLE 7

| Pluronic F68 | Viscosity, 2.1 wt % TexCare ™ | Viscosity, no TexCare ™ |
|---|---|---|
| (wt %) | (Pa · s) | (Pa · s) |
| 0 | 0.141 | 0.0564 |
| 0.33 | 0.162 | 0.0158 |
| 0.66 | 0.551 | 0.0246 |
| 1 | 0.796 | 0.0348 |
| 1.33 | 0.751 | 0.0454 |
| 1.5 | 1.860 | |

TABLE 8

| TexCare ™ 170 | Viscosity, 1% Pluronic F68 | Viscosity, no Pluronic |
|---|---|---|
| (wt %) | (Pa · s) | (Pa · s) |
| 0.0 | 0.067 | 0.056 |
| 0.7 | 0.126 | 0.084 |
| 1.4 | 0.457 | 0.069 |
| 2.1 | 1.180 | 0.141 |
| 3.0 | 1.700 | |

### Example 6

### Selection of HEDP Salt

It was determined that the Sodium salt of HEDP induced crystallization in all cases whereas the Potassium salt of HEDP did not. Use of sodium alkyl ether sulphate did not appear to unduly promote the formation of sodium salts of HEDP in the liquid. On the other hand use of sodium chloride as a gel former or sodium hydroxide to neutralise the LAS acid always caused the HEDP to crystallise out.

1. A free flowing aqueous lamellar gel laundry detergent liquid comprising, in addition to water:
a) 20 to 35 wt % of a surfactant system in the form of vesicles comprising potassium neutralised linear alky benzene sulfonate anionic surfactant (LAS), alkyl ether sulphate anionic surfactant (AES) and nonionic surfactants,
b) at least 3 wt % of a first nonionic polymeric material (EPEI) which is a water-soluble fabric cleaning polymer;
c) from 0.1 to 1 wt % of a second nonionic polymeric material which is a tri-block polymer with a hydrophobic midblock and two hydrophilic end-blocks with an HLB of at least 20
d) optionally, a polyester soil release polymer and
e) optionally, at least 2 wt % 1-hydroxyethane 1,1-diphosphonic acid (HEDP).

2. A composition according to claim 1 wherein the ratio LAS:AES:NI is in the range from: 1.5 to 2.5:0.7 to 1.5:1 to 2.

3. A composition according to any preceding claim in which the first nonionic polymeric material is ethoxylated polyethyleneimine, (EPEI), preferably it is PEI(600)20EO, a polymer with polyethyleneimine of average molecular weight 600 ethoxylated with ethylene oxide to give an average of 20 ethylene oxides per nitrogen.

4. A composition according to claim 1 wherein the polyester soil release polymer (d) is included in an amount of from 1 to 5 wt %.

5. A composition according to claim 1 wherein the polyester soil release polymer comprises polyethylene terephthalate mid-blocks and polyethylene oxide (PEG) end block(s).

6. A composition according to claim 1 which further comprises: enzymes.

7. A composition according to claim 1 wherein the second nonionic polymer is a PEO-PPO-PEO tri-block copolymer of formula (I): 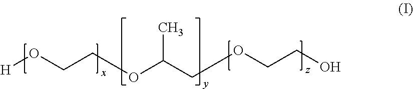
Wherein the HLB is at least 20.

8. A composition according to claim 7 wherein:
x and z (PEG end-block) is from 40 to 132, preferably x is equal to z, and
y (hydrophobic PPO mid-block) is from 16 to 68.

9. A composition according to claim 8 wherein the second nonionic material is Pluronic F68 which has an HLB of 29.

10. A composition according to claim 1 wherein:
LAS:AES:NI ratio: 1.5 to 2.5:0.7 to 1.5:1 to 2; preferably LAS:SLES:NI: 2:1:1.5; and
Surfactant Level: 20 to 35 wt %, preferably 23 to 27 wt %; and
EPEI Level: 3 to 4 wt %; and
Pluronic: 0.5 to 0.6 wt %; and
Pluronic HLB: 20 to 30.
